(19) United States
(12) Patent Application Publication
(10) Pub. No.: US 2023/0125261 A1
(43) Pub. Date: Apr. 27, 2023

(54) SYSTEM AND METHOD FOR MANAGING BATTERY TEMPERATURES IN A BATTERY PACK

(71) Applicant: Hyliion Inc., Cedar Park, TX (US)

(72) Inventors: Geethanjali Gadamchetty, Pflugerville, TX (US); Hemal Mamtora, Austin, TX (US); Robert Butler, Liberty Hill, TX (US); Brian Schoolcraft, Cedar Park, TX (US); Kyle Lawrence Torrico, Boulder, CO (US)

(21) Appl. No.: 17/507,614

(22) Filed: Oct. 21, 2021

(51) Int. Cl. H01M 10/6568; H01M 10/613; H01M 10/653; H01M 10/63; H01M 10/6556; H01M 50/249; H01M 10/625

(52) U.S. Cl. CPC H01M 10/6568; H01M 10/613; H01M 10/653; H01M 10/63; H01M 10/6556; H01M 50/249; H01M 10/625; H01M 2220/20

(57) ABSTRACT

A cooling system for a battery pack in a vehicle comprises a base plate, a plurality of transverse members, a pump, a controller, and a heat exchanger. The controller causes the pump to generate fluid flow into an inlet/outlet port of the base plate. The base plate comprises a channel with segments for supplying fluid to a first set of fluid distribution ports and receiving fluid from a second set of fluid distribution ports. Each fluid distribution port is in fluid communication with a main conduit of a transverse member and transverse conduits connect the main conduits of a transverse member. Fluid flow through the channel in the base plate and the main conduits and transverse conduits of the transverse members cool the batteries and distribute heat. Cooling multiple sides of the batteries reduces the operating temperature to reduce charging times and extend the service life of the batteries.

### BACKGROUND

### Field of the Disclosure

This disclosure relates generally to battery systems for driving large vehicles and, more particularly, to a system and method for managing the temperatures of a plurality of batteries in a battery pack.

### Description of the Related Art

Large, wheeled vehicles may be used to efficiently transport cargo such as by pulling trailers to transport large volumes of cargo. The combination of the vehicle and the trailer can weigh between 30,000 pounds up to 140,000 pounds for a tandem loaded trailer. These vehicles may be referred to as “powered semi-tractors,” “semi-tractors,” “semis,” or “trucks.” Trucks may be used on roads such as highways and in urban areas but may also be used on unimproved roads or uneven terrain. In a traditional truck with an internal combustion engine, the internal combustion engine may be sized in the range of 15 liters to provide enough power to propel the vehicle and the trailer.

### SUMMARY

In one aspect, a cooling system for a battery pack comprising a plurality of batteries comprises a base plate, a plurality of transverse members, a pump for generating fluid flow through the base plate and the plurality of transverse members and a controller executing a set of instructions for causing the pump to generate the fluid flow.

The base plate comprises a first inlet/outlet port proximate a first end of the base plate, a second inlet/outlet port proximate a second end of the base plate opposite the first end, a first set of fluid distribution ports proximate a first edge of the base plate, a second set of fluid distribution ports proximate a second edge of the base plate opposite the first edge, and a channel having a first set of segments in fluid communication with the first inlet/outlet port and the first set of fluid distribution ports and a second set of segments in fluid communication with the second inlet/outlet port and the second set of fluid distribution ports. In some embodiments, the channel comprises a plurality of segments. In some embodiments, the cooling system includes thermally conductive material between the plurality of batteries and the base plate.

Each transverse member is coupled to the base plate and comprises a first main conduit for receiving fluid from the first set of fluid distribution ports, a second main conduit for supplying fluid to the second set of fluid distribution ports, and a set of transverse conduits in fluid communication with the first main conduit and the second main conduit, wherein fluid flow from the first main conduit is distributed to the set of transverse conduits.

In some embodiments, the pump is operable to generate the fluid flow in a first direction or a second direction opposite the first direction, wherein the controller executes a set of instructions to cause the pump to generate the fluid flow having a fluid flow rate in the first direction or the second direction. In some embodiments, the controller executes a set of instructions to cause the pump to generate the fluid flow having a fluid flow rate in the first direction or the second direction based on a target temperature profile for the plurality of batteries.

In some embodiments, the pump generates fluid flow in a fluid circuit including the battery pack and at least one heat exchanger. The fluid flows through a first inlet/outlet port, a first portion of the channel, a first set of fluid distribution ports, a first main conduit, a set of transverse conduits, a second main conduit, a second set of fluid distribution ports, a second portion of the channel and out a second inlet/outlet port. Fluid exiting the battery pack flows through a fluid circuit having hoses or lines and fittings to a heat exchanger for removing heat from the batteries or adding heat to the batteries. Fluid exiting the heat exchanger flows back to the pump to repeat the cycle.

Embodiments may cool or warm one or more battery packs on a large vehicle such as a truck. Each battery pack may be oriented relative to a horizontal plane or vertical plane. Embodiments may cool or warm each battery pack individually or cool multiple battery packs collectively.

### BRIEF DESCRIPTION OF THE DRAWINGS

For a more complete understanding of the present invention and its features and advantages, reference is now made to the following description, taken in conjunction with the accompanying drawings, in which:

FIG. 1 depicts a perspective view of a battery pack forming part of a drivetrain for a wheeled vehicle capable of transporting cargo over an extended range;

FIG. 2 depicts an exploded perspective view of the embodiment of a battery pack depicted in FIG. 1;

FIG. 3 depicts a cutaway end view of the embodiment of a battery pack depicted in FIG. 1;

FIG. 4 depicts a cutaway view of a base plate of the embodiment of a battery pack depicted in FIG. 1;

FIG. 5 depicts a cutaway end view of one embodiment of a transverse member of the embodiment of a battery pack depicted in FIG. 1; and

FIG. 6 depicts a cutaway side view of the embodiment of a battery pack depicted in FIG. 1.

### DETAILED DESCRIPTION

In the following description, details are set forth by way of example to facilitate discussion of the disclosed subject matter. It should be apparent to a person of ordinary skill in the field, however, that the disclosed embodiments are exemplary and not exhaustive of all possible embodiments.

For the purposes of this disclosure, embodiments are described as they pertain to a vehicle having a cab on a chassis with an engine coupled to a first set of axles, a motor/generator (“M/G”) coupled to a second set of axles, a battery system comprising a plurality of batteries in a battery pack and a controller executing a set of instructions to manage operation of one or more of the engine, the M/G and the battery system to drive the vehicle on a route.

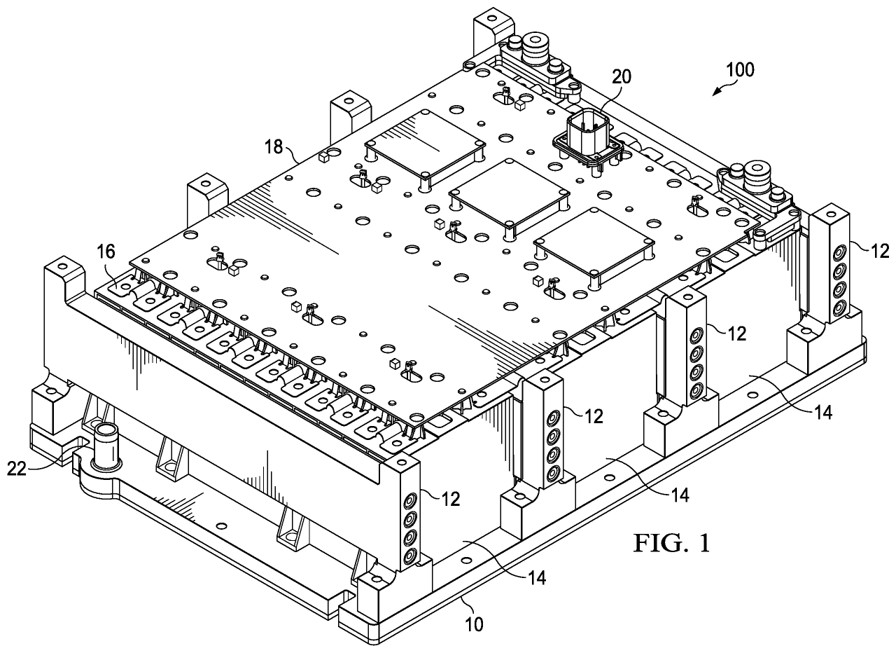

Particular embodiments may be best understood by reference to FIGS. 1-6, wherein like numbers are used to indicate like and corresponding parts.

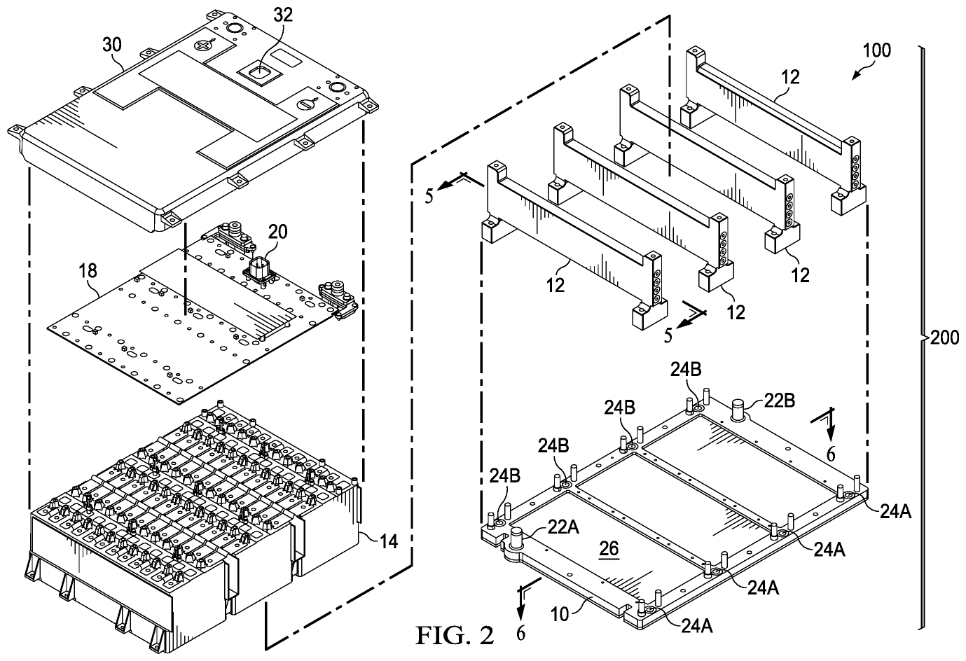

Turning now to the drawings, FIGS. 1 and 2 depict partial perspective and exploded perspective views of one embodiment of a battery pack 100 for use in a large vehicle such as a bus with an attached passenger compartment, a truck with an attached cargo compartment or a semi-tractor used to pull one or more trailers, each trailer comprising a cargo compartment.

As shown in FIGS. 1 and 2, components of battery pack 100 may include, but are not limited to a plurality of batteries 14, a power plate 18 electrically coupled to posts 16 of each battery 14. Posts 16 of batteries 14 are electrically connected to power plate 18 such that electrical power discharged from battery pack 100 can be supplied via receptacle 20 extending through opening 32 in cover 30, and electrical power can be received via receptacle 20 to charge batteries 14.

Also shown in FIGS. 1 and 2, components of battery pack 100 may include, but are not limited to, base plate 10, a plurality of transverse members 12 coupled to base plate 10 and cover 30 coupled to base plate 10 for sealing battery pack 100. Batteries 14 may be positioned in recessed areas 26 of base plate 10. Each recessed area 26 may include thermally conductive material for increasing heat transfer between batteries 14 and base plate 10. Transverse members 12 may be positioned on both sides of each row of batteries 14. Transverse members 12 may comprise thermally conductive material. Cover 30 may ensure battery pack 100 is sealed. In some embodiments, cover 30 may provide additional structural support to allow battery pack 100 to be oriented with base plate 10 below batteries 14 (e.g., aligned relative to a horizontal plane) as well as other orientations in which base plate 10 is oriented relative to a vertical plane.

Charging and discharging a battery 14 generates heat, wherein a temperature associated with charging and discharging battery 14 may be higher at locations closer to posts 16. The highest temperature of a battery 14 may affect how quickly battery 14 can be charged and how efficiently battery 14 can be charged. A temperature profile of battery 14 with a large difference between a high temperature near posts 16 and a lower temperature at a location opposite posts 16 may indicate poor heat transfer. A temperature profile with a large difference may indicate stress on the battery 14 which could affect the service life of the battery 14.

### Cooling System Overview

Cooling system 200 generally comprises base plate 10, transverse members 12, a heat exchanger (not shown) in fluid communication with base plate 10, a pump (not shown) for causing fluid flow and a controller (not shown) executing instructions to cause the pump to generate fluid flow in a selected direction and flow rate through base plate 10, transverse members 12 and a fluid circuit to the heat exchanger. Cooling system 200 further comprises a fluid circuit including hoses and lines through which the fluid can flow and a set of valves, wherein the controller executes instructions to open or close valves in the set of valves to direct the fluid to flow through a set of hoses or lines to transfer heat to/from batteries 14 to/from a heat exchanger (discussed in greater detail below).

Base plate 10 may comprise inlet/outlet ports 22 such that base plate 10 is in fluid communication with the heat exchanger and pump. For ease of understanding, inlet/outlet ports 22 are referred to herein as being located proximate to ends of base plate 10. Fluid from the heat exchanger may enter a first inlet/outlet port proximate a first end of base plate 10 and fluid may exit a second inlet/outlet port proximate a second end of base plate 10 to return to the heat exchanger. The controller may communicate with the pump to control the direction of fluid flow such that either inlet/outlet port 22A or inlet/outlet port 22B may function as the inlet port 22 or the outlet port 22. Fluid flow through base plate 10 may remove heat from batteries 14 and may distribute heat among batteries 14.

Base plate 10 further includes fluid distribution ports 24. For ease of understanding, fluid distribution ports 24 are referred to herein as being located proximate to edges of base plate 10. Fluid circulating through base plate 10 may flow through a first set of fluid distribution ports 24 (e.g., fluid distribution ports 24A) proximate a first edge to flow through transverse members 12 and return to base plate 10 through a second set of fluid distribution ports 24 (e.g., fluid distribution ports 24B) proximate a second edge. Fluid flow through transverse members 12 may transfer some heat from the sides of batteries 14 to fluid flowing through base plate 10 to further cool batteries 14.

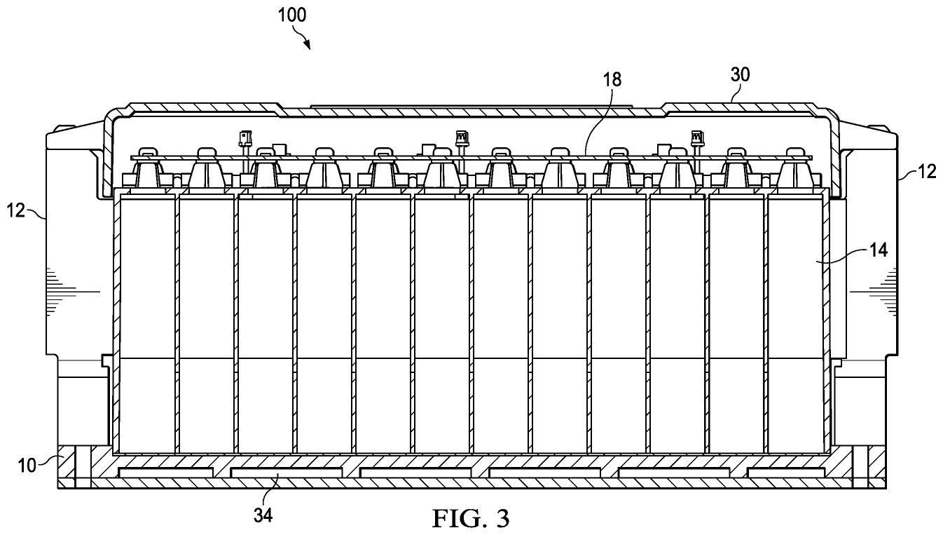

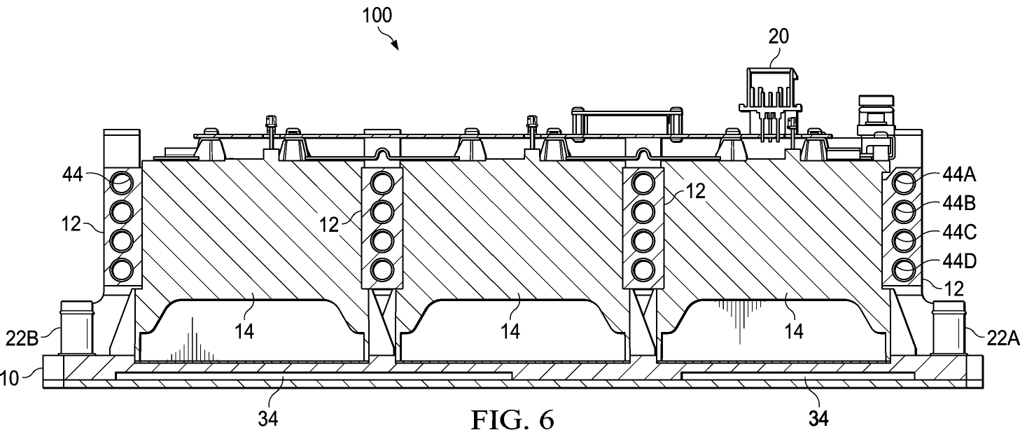

Referring to FIGS. 3-6, battery pack 100 may have a plurality of batteries 14 (a row of twelve batteries 14 is depicted in FIG. 3) as an array of batteries 14 (three rows of batteries 14 are depicted in FIG. 6), wherein transverse members 12 are positioned on both sides of each row of batteries 14 (four transverse members 12 are depicted relative to three rows of batteries 14 in FIG. 6).

Referring to FIGS. 3-6, embodiments of base plate 10 comprise a first inlet/outlet port 22 for receiving fluid flow from a pump, a fluid channel 34 comprising a plurality of segments 50 for directing fluid through base plate 10 and a second inlet/outlet port 22 for directing fluid flow to a heat exchanger.

### Base Plate Cools Bottom of Batteries and Distributes Fluid to Transverse Members

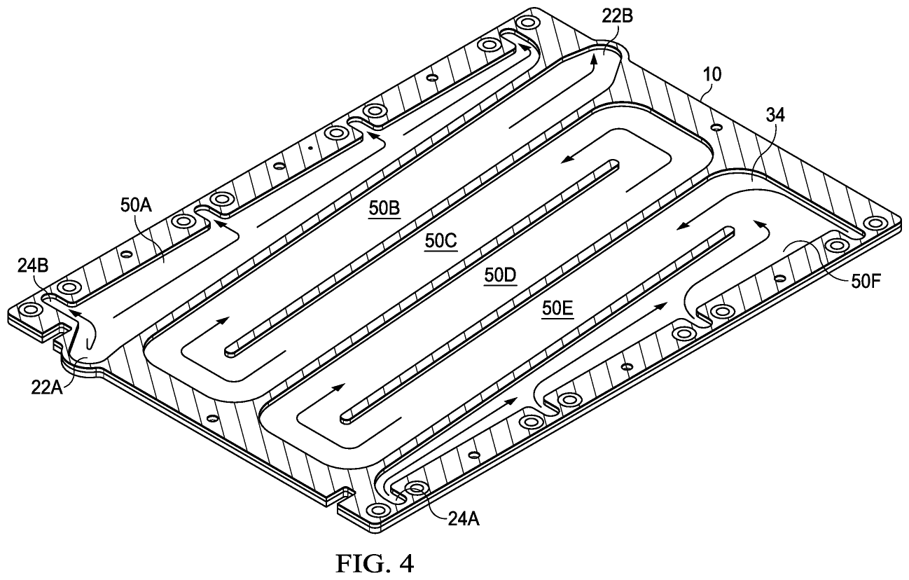

Referring to FIG. 4, base plate 10 comprises channel 34 in fluid communication with inlet/outlet ports 22 and fluid distribution ports 24, wherein channel 34 comprises a plurality of segments 50. Fluid flow through channel 34 in base plate 10 may facilitate heat transfer relative to a plurality of batteries 14 and may further distribute heat among the plurality of batteries 14. For example, if battery pack 100 is operating in cold conditions, batteries 14 located near the edges or ends of battery pack 100 may be cold but batteries 14 near the center may be much warmer. Embodiments may distribute heat such that all batteries 14 have approximately the same temperature profile.

As depicted in FIG. 4, in some configurations, fluid may enter base plate 10 via first inlet/outlet port 22A and a first segment 50A of channel 34 may direct the fluid flow to a first set of fluid distribution ports 24B in fluid communication with a plurality of transverse members (not shown in FIG. 4). Fluid may be received from the plurality of transverse members 12 by a second set of fluid distribution ports 24A in fluid communication with segment 50F, wherein segments 50B-50F in channel 34 direct the fluid flow to second inlet/outlet port 22B. In other configurations (not shown), fluid may enter base plate 10 via inlet/outlet port 22B and segments 50B-50F in channel 34 may direct the fluid flow to a first set of fluid distribution ports 24A. Fluid may be received by a second set of fluid distribution ports 24B and segment 50A in channel 48 may direct the fluid flow to inlet/outlet port 22A.

The direction of fluid flow through base plate 10 may be determined by a controller (not shown). In various configurations, the direction of fluid flow may be selected to remove heat from batteries 14, add heat to batteries 14 or to provide a desired temperature profile of batteries 14. The number, shape, and orientation of segments 50 in channel 34 may vary. For example, channel 34 may be configured with fewer or more segments 50 and segments 50 may be straight (as depicted in FIG. 4), curved or some combination.

### Transverse Members Cool Sides of Batteries

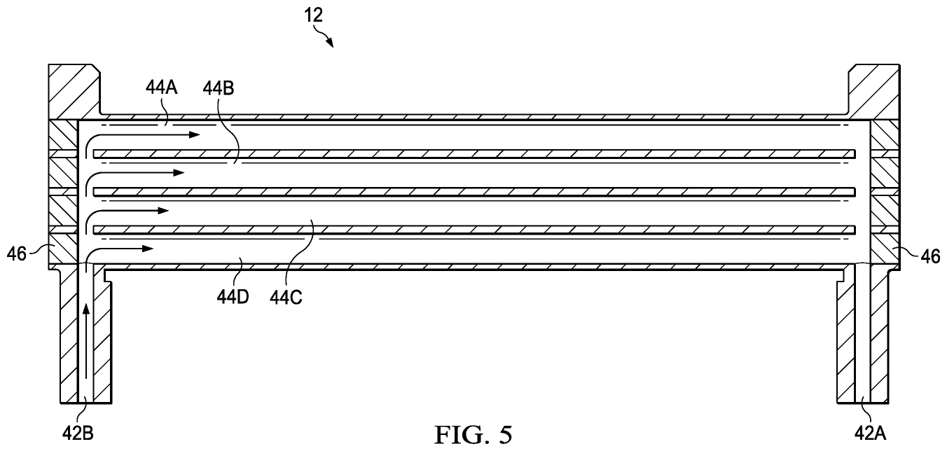

Referring to FIGS. 5 and 6, each transverse member 12 comprises main conduits 42 and transverse conduits 44.

In some embodiments, each main conduit 42 may be formed by machining material from transverse member 12. A first main conduit 42 receives fluid from a first set of fluid distribution ports 24 in base plate 10. The first main conduit 42 distributes fluid through a set of transverse conduits 44 for cooling batteries 14 to a second main conduit 42. The second main conduit 42 returns fluid to base plate 10 via a second set of fluid distribution ports 24. Embodiments of a battery cooling system may generate fluid flow in either direction such that either main conduit 42 may function as the first main conduit 42A or the second main conduit 42B.

Each transverse conduit 44 fluidly connects a first main conduit (e.g., main conduit 42A) to a second main conduit (e.g., main conduit 42B) such that fluid received from fluid distribution ports 24 flows between main conduits 42. In some embodiments, each transverse conduit 44 is formed by machining material from transverse member 12 between main conduits 42 and then installing one or more plugs 46 in the ends of the transverse conduit 44 to seal the ends of the transverse conduit 44. Transverse members 12 are coupled to base plate 10 such that main conduits 42 are in fluid communication with fluid distribution ports 24. The internal diameter of each transverse conduit 44 may affect the distribution of fluid flow through transverse conduits 44. For example, as depicted in FIG. 5, in some embodiments the internal diameters of transverse conduits 44 cause the most fluid flow through transverse conduit 44A and the least fluid flow through transverse conduit 44D. Advantageously, for battery pack 100 in which heat tends to accumulate near posts 16 in batteries 14, the increased fluid flow through transverse conduit 44A may cool batteries 14 more efficiently and the temperature profile of each battery 14 is more uniform. In the short term, the ability to cool batteries 14 more efficiently allows batteries 14 to be charged more quickly. For example, battery pack 100 may be charged in approximately half the time as a traditionally cooled battery system. In the long term, the ability to manage the temperature profile may extend the service life of batteries 14.

### Battery Management System

A battery management system (BMS) facilitates a vehicle operating under a range of environmental, economic, and regulatory conditions. A BMS may control when to charge batteries 14 and when batteries 14 are available to supply electric power to a motor to drive the vehicle. For example, the BMS may anticipate future power needs and communicate instructions to operate the engine to charge batteries 14.

In some embodiments, a BMS controller may determine a weight of the vehicle and calculate how much electrical power a regenerative braking system may capture to charge batteries 14. In some embodiments, a BMS controller may determine the weight of the vehicle, analyze the route or terrain, and determine when to charge batteries 14, when to operate the engine to provide direct power to drive the vehicle and when to operate the engine to supply rotational power to the M/G operating as a generator to charge batteries 14 or supply electrical power to a second M/G to drive the vehicle. In some embodiments, a BMS controller may determine the weight of the vehicle, analyze the route or terrain, and determine how much regenerative power is available to charge batteries 14 including coast down charging. In some embodiments, a BMS controller may receive an input from a driver or communicate over a network with a server to identify a route and charge batteries 14 based on the route, including terrain on the route. In some embodiments, a BMS controller analyzes topographical data and adjusts the performance, the state of charge (SOC) and the operating temperature of batteries 14 and/or communicate with an ECU to adjust the performance of the engine based on the topographical data.

A BMS may communicate with a set of sensors to monitor a set of operating parameters of batteries 14 to determine when batteries 14 need cooling. In some embodiments, the BMS may determine batteries 14 need cooling based on an operating temperature of one or batteries 14 at or nearing a maximum operating temperature. For example, a BMS may communicate with a set of sensors to determine when a temperature of the one or more batteries 14 is at or near a maximum operating condition and communicate with a pump to generate fluid flow to cool the one or more batteries 14.

In some embodiments, the BMS may determine batteries 14 need cooling based on a temperature profile of one or more batteries 14. A battery 14 might not have a consistent temperature, such as a first temperature near posts 16 being significantly higher than a second temperature taken at a location opposite posts 16, even though the first temperature may be less than a maximum operating temperature. The BMS may communicate with a pump to generate fluid flow through battery pack 100 such that the difference between the highest and lowest operating temperatures associated with a battery 14 is less than a maximum difference. A maximum difference may be based on ensuring large temperature differences do not result in a decrease in service life of the battery 14. A target temperature profile may correspond to a maximum temperature difference between the highest temperature and the lowest temperature of a battery 14.

Embodiments described herein may form part of a thermal management system for a vehicle.

### Thermal Management System

A thermal management system for a vehicle includes a set of sensors and a controller executing instructions to communicate with the set of sensors to determine values of operating parameters such as operating temperatures of battery pack 100 or batteries 14 inside battery pack 100, an engine, a M/G, a cab or cabin and ambient air conditions and operate a cooling system to manage the operating parameters.

In some embodiments, a thermal management system executes instructions to determine, based on a temperature of batteries 14 and a temperature of the engine, the cab and the ambient environment, a fluid flow rate, a direction of fluid flow, and a fluid circuit and operate a pump to circulate fluid around batteries 14, wherein the thermal management system may communicate with the pump to control a direction of fluid flow through and a flow volume through battery pack 100 and the fluid circuit.

The thermal management system may execute instructions to operate one or more valves associated with an exhaust heat exchanger to add heat to batteries 14. In some embodiments, the thermal management system communicates with an engine control module (ECU) to determine the engine is operating, determines the fluid temperature in a cooling system for the engine, and executes instructions to operate a pump and one or more valves in the cooling system to transfer heat from batteries 14 to warm the engine, transfer heat from the engine to warm batteries 14 or transfer heat from batteries 14 and the engine to the ambient environment. For example, under some ambient conditions, the ambient air temperature might be extremely cold such that operation of batteries 14 is negatively affected. A thermal management system may determine the temperature of batteries 14 is below a minimum operating temperature and execute a set of instructions to communicate with the ECU to start the engine, communicate instructions to a pump to generate fluid flow past batteries 14 in battery pack 100, and communicate instructions to a set of valves to open a fluid circuit to extract heat from the exhaust gases of the engine when the engine operating temperature is above a minimum temperature.

The thermal management system may communicate with a cab or cabin temperature control unit to determine a cab or cabin temperature and execute instructions to operate a compressor and one or more valves associated with a fluid circuit of a refrigerant system to transfer heat from batteries 14 to warm the cab or cabin, transfer heat from the cab or cabin to warm batteries 14 or transfer heat from batteries 14 and the cab or cabin to the ambient environment. For example, under some ambient air conditions, the temperature of ambient air may be sufficient to cool batteries 14 but too cold for the driver's comfort. In these conditions, heat from batteries 14 may be used to warm a cab or passenger compartment.

The thermal management system may open or close valves associated with a fluid circuit of a cooling system to extract heat from the engine for warming batteries 14 to a preferred operating temperature. A controller may determine an operating temperature of batteries 14 is cooler than a minimum operating temperature, determine that an ambient air temperature is too low to effectively heat batteries 14 but determine the temperature of coolant in an engine cooling system may efficiently heat batteries 14. The controller may open or close one or more valves to route coolant through a first heat exchanger to transfer heat to batteries 14. If batteries 14 are operating above a minimum operating temperature, the controller may open or close one or more valves to route coolant through a second heat exchanger such that heat transfer occurs from batteries 14 to the ambient environment. For example, the controller may determine at start up that one or more batteries 14 in battery pack 100 are below a desired temperature threshold and send a set of signals to cause the pump to generate fluid flow in a first direction and open or close valves of a first fluid circuit such that the cooling system extracts heat from the engine and transfers the heat to battery pack 100 to warm batteries 14. The controller may determine after some time that one or more batteries 14 in battery pack 100 have reached a desired temperature threshold and send a set of signals to cause the pump to still generate fluid flow in the first direction and open or close valves of the first fluid circuit such that the cooling system does not transfer heat from the engine. The controller may determine after some time that one or more batteries 14 in battery pack 100 require cooling and send a set of signals to cause the pump to still increase fluid flow in the first direction and open or close valves of a second fluid circuit such that the cooling system transfers heat from the batteries 14 to a heat exchanger for transferring heat to the ambient air.

### Drivetrain

In some embodiments, a drivetrain for a vehicle may comprise a motor/generator (“M/G”) (not shown) coupled to at least one axle and battery pack 100 connected to the M/G such that electrical power discharged from battery pack 100 may be supplied to the M/G operating as a motor to generate rotational power for rotating wheels coupled to the axle and rotational power supplied by the axles may be used to rotate the M/G operating as a generator to generate electrical power to charge battery pack 100. In some embodiments, a M/G may be integrated with an axle in an e-axle configuration or located in a hub of a wheel coupled to the axle as a hub motor configuration. In some embodiments, the drivetrain may comprise an engine (not shown) that can be selectively engaged with the M/G, wherein rotational power supplied by the engine may be used to rotate the M/G operating as a generator to generate electrical power to charge battery pack 100. In some embodiments, a first M/G may be coupled to the engine and operate as a generator and a second M/G may be coupled with an axle in an e-axle configuration or located in a hub of a wheel coupled to the axle as a hub motor configuration, wherein a first portion of the electrical power generated by the first M/G may be used to charge batteries 14 and a second portion of the electrical power generated by the first M/G may be supplied to the second M/G to drive the vehicle.

### Vehicle

A vehicle may comprise a chassis with embodiments of a drivetrain described above with battery pack 100 connected to a M/G such that electrical power discharged from battery pack 100 may be supplied to the M/G to generate rotational power for rotating wheels coupled to the axle and rotational power supplied by the axle may rotate the M/G to generate electrical power to charge battery pack 100. Battery pack 100 may be positioned in various locations on a vehicle. In some embodiments, one or more battery packs 100 may be coupled to a chassis (not shown). In some embodiments, one or more battery packs 100 may be located between, under or around the rails of chassis. The one or more battery packs 100 may be connected in series, parallel or some combination.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

1-14. (canceled)

15. A battery pack, comprising:
a base plate comprising:
a first inlet/outlet port proximate a first end;
a second inlet/outlet port proximate a second end opposite the first end;
a first set of fluid distribution ports proximate a first side;
a second set of fluid distribution ports proximate a second side opposite the first side; and
a first channel connecting the first inlet/outlet port and the first set of fluid distribution ports in fluid communication; and
a second channel connecting the second inlet/outlet port and the second set of fluid distribution ports in fluid communication;
a plurality of batteries arranged on the base plate;
a plurality of transverse members, each transverse member coupled to the base plate and comprising:
a first main conduit for receiving fluid from one of the first set of fluid distribution ports;
a second main conduit for supplying fluid to one of the second set of fluid distribution ports; and
one or more transverse conduits in fluid communication with the first main conduit and the second main conduit, wherein fluid flow from the first main conduit is distributed through the one or more transverse conduits and to the second main conduit; and
a cover coupled to the base plate for sealing the battery pack.

16. The battery pack of claim 15, wherein the batteries are arranged into a plurality of rows across the base plate.

17. The battery pack of claim 16, wherein the transverse members are positioned on both sides of each row of batteries.

18. The battery pack of claim 17, wherein the transverse members comprise a thermally conductive material for increasing heat transfer with the batteries.

19. The battery pack of claim 15, wherein the batteries are positioned in recessed areas of the base plate.

20. The battery pack of claim 19, wherein the recessed areas comprise a thermally conductive material for increasing heat transfer with the batteries.

21. The battery pack of claim 15, wherein at least one of the first channel and the second channel comprises a plurality of segments.

22. The battery pack of claim 15, further comprising: a power plate electrically coupling the batteries.

23. The battery pack of claim 22, wherein the power plate comprises a receptacle through which electrical power can be selectively received and supplied.

24. The battery pack of claim 24, wherein the receptacle extends through an opening in the cover.

25. The battery pack of claim 15, wherein the battery pack is coupled to a pump that is operable to selectively generate the fluid flow through the first inlet/outlet port, the first set of segments of the channel, the first set of fluid distribution ports, the first main conduits, the one or more transverse conduits, the second main conduits, the second set of fluid distribution ports, the second set of segments of the channel, and the second inlet/outlet port.

26. A battery system for a vehicle, comprising:
a plurality of battery packs, each battery pack comprising:
a base plate comprising:
a first inlet/outlet port proximate a first end;
a second inlet/outlet port proximate a second end opposite the first end;
a first set of fluid distribution ports proximate a first side;
a second set of fluid distribution ports proximate a second side opposite the first side;
a first channel connecting the first inlet/outlet port and the first set of fluid distribution ports in fluid communication; and
a second channel connecting the second inlet/outlet port and the second set of fluid distribution ports in fluid communication;
a plurality of batteries arranged on the base plate;
a plurality of transverse members, each transverse member coupled to the base plate and comprising:
a first main conduit for receiving fluid from one of the first set of fluid distribution ports;
a second main conduit for supplying fluid to one of the second set of fluid distribution ports; and
one or more transverse conduits in fluid communication with the first main conduit and the second main conduit, wherein fluid flow from the first main conduit is distributed through the one or more transverse conduits and to the second main conduit; and
a cover coupled to the base plate for sealing the battery pack;
one or more heat exchangers;
a pump for generating fluid flow through the battery packs and the one or more heat exchangers; and
a controller selectively executing a set of instructions to cause the pump to generate the fluid flow to remove heat from the batteries, redistribute heat among the batteries, or a combination thereof.

27. The battery system of claim 26, wherein the batteries are arranged into a plurality of rows across the base plate.

28. The battery system of claim 27, wherein the transverse members are positioned on both sides of each row of batteries.

29. The battery system of claim 28, wherein the transverse members comprise a thermally conductive material for increasing heat transfer with the batteries.

30. The battery system of claim 26, wherein the batteries are positioned in recessed areas of the base plate.

31. The battery system of claim 30, wherein the recessed areas comprise a thermally conductive material for increasing heat transfer with the batteries.

32. The battery system of claim 26, wherein at least one of the first channel and the second channel comprises a plurality of segments.

33. The battery system of claim 26, further comprising: a power plate electrically coupling the batteries and comprising a receptacle through which electrical power can be selectively received and supplied, wherein the receptacle extends through an opening in the cover.

34. The battery system of claim 26, wherein the pump is operable to generate the fluid flow through the battery packs and the one or more heat exchangers in a first direction or a second direction opposite the first direction.

35. The battery system of claim 34, wherein the controller executes a set of instructions to cause the pump to generate the fluid flow having a fluid flow rate in the first direction or the second direction based on a target temperature profile for the batteries.

36. The battery system of claim 35, wherein the controller communicates with one or more sensors to determine when to operate the pump to cool the batteries.
